(19) United States
(12) Patent Application Publication
(10) Pub. No.: US 2013/0258401 A1
(43) Pub. Date: Oct. 3, 2013

(54) INFORMATION PROCESSING APPARATUS, IMAGE FORMING APPARATUS AND IMAGE FORMING SYSTEM

(71) Applicants: KABUSHIKI KAISHA TOSHIBA, Tokyo (JP); TOSHIBA TEC KABUSHIKI KAISHA, Tokyo (JP)

(72) Inventor: Takaaki Suzuki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/790,519

(22) Filed: Mar. 8, 2013

Related U.S. Application Data
(60) Provisional application No. 61/619,499, filed on Apr. 3, 2012.

(51) Int. Cl. G06F 3/12

(52) U.S. Cl. CPC G06F 3/1221
USPC 358/1.15

(57) ABSTRACT

According to an embodiment, an information processing apparatus comprises a wireless communication interface, an exploration unit, a communication establishment unit and a communication processing unit. The wireless communication interface carries out wireless communication. The exploration unit explores an image forming apparatus that is the state that can be connected by wireless communication based on a wireless access point function. The communication establishment unit establishes the wireless communication connection with the image forming apparatus that is the state that can be connected by wireless communication based on a wireless access point function. The communication processing unit supplies an on signal turning on the wireless access point function to the image forming apparatus whose wireless access point function is off when the exploration unit determines that the image forming apparatus that is the state that can be connected by wireless communication based on, a wireless access point function does not exist.

### CROSS-REFERENCE TO RELATED APPLICATIONS

This application is based upon and claims the benefit of priority from U.S. Provisional Application No. 61/619,499 filed on Apr. 3, 2012; the entire contents of which are incorporated herein by reference.

### FIELD

Embodiments described herein relate to an information processing apparatus, an image forming apparatus and an image forming system.

### BACKGROUND

An image forming apparatus comprises an apparatus with a wireless communication function. The image forming apparatus with the wireless communication function can carry out wireless communication with an information processing apparatus by a wireless access point (AP) function. If the wireless AP functions of all the image forming apparatuses are all in an on state, the power consumption of a system comprising a plurality of image forming apparatuses is increased.

### BRIEF DESCRIPTION OF THE DRAWINGS

FIG. 1 roughly illustrates a configuration example of an image forming system according to embodiment 1;

FIG. 2 is a block diagram roughly illustrating a configuration example of an information processing apparatus according to embodiment 1;

FIG. 3 is a block diagram roughly illustrating a configuration example of an image forming apparatus according to embodiment 1;

FIG. 4 shows a state example of the image forming apparatus according to embodiment 1;

FIG. 5 shows another state example of the image forming apparatus according to embodiment 1;

FIG. 6 is a flow chart describing an action example of the information processing apparatus according to embodiment 1;

FIG. 7 is a flow chart describing an action example of the image forming apparatus according to embodiment 1;

FIG. 8 is a flow chart describing an action example of an information processing apparatus according to embodiment 2; and

FIG. 9 is a flow chart describing an action example of an image forming apparatus according to embodiment 2.

### DETAILED DESCRIPTION

According to an embodiment, an information processing apparatus comprises a wireless communication interface, an exploration unit, a communication establishment unit and a communication processing unit. The wireless communication interface carries out wireless communication. The exploration unit explores an image forming apparatus that is the state that can be connected by wireless communication based on a wireless access point function. The communication establishment unit establishes the wireless communication connection with the image forming apparatus that is the state that can be connected by wireless communication based on a wireless access point function. The communication processing unit supplies an on signal turning on the wireless access point function to the image forming apparatus whose wireless access point function is off when the exploration unit determines that the image forming apparatus that is the state that can be connected by wireless communication based on a wireless access point function does not exist.

### Embodiment 1

First, the embodiment 1 is described.

Hereinafter, it is described with reference to drawings.

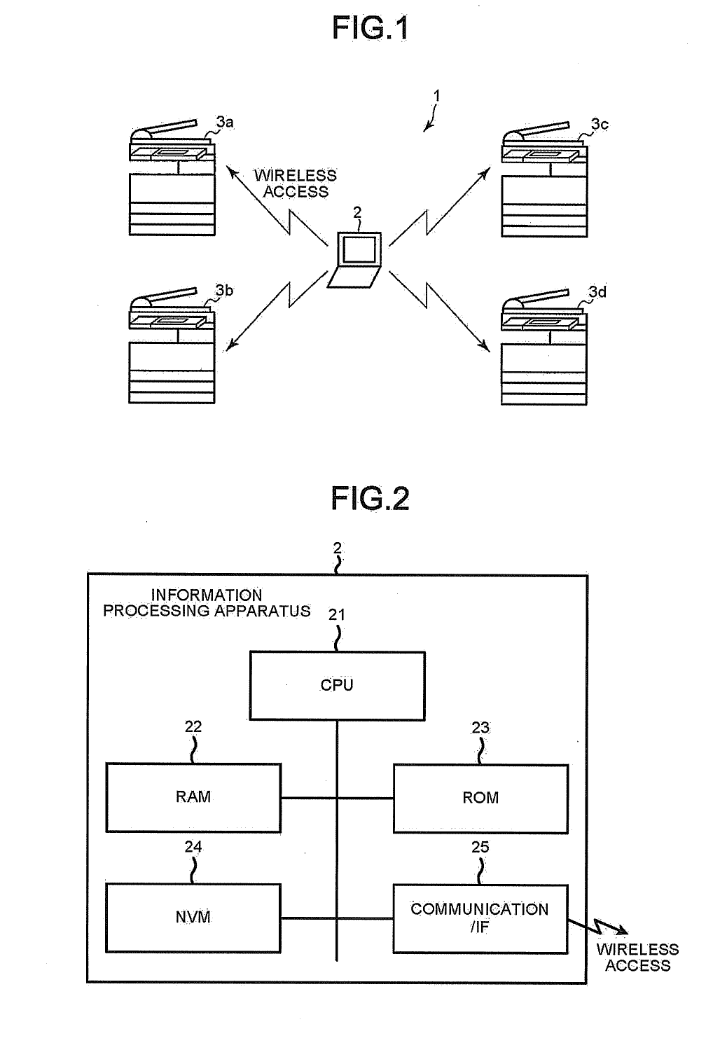

FIG. 1 roughly illustrates a configuration example of an image forming system 1 according to the embodiment.

As shown in FIG. 1, the image forming system 1 comprises an information processing apparatus 2 and image forming apparatuses 3a-3d.

The image forming system 1 is a system forming an image on paper and the like according to an instruction from the information processing apparatus 2. When the information processing apparatus 2 prints the image according to an instruction of a user and the like, the information processing apparatus 2 selects one image forming apparatus 3 from the image forming apparatuses 3a-3d and sends an instruction of printing the image to the selected image forming apparatus 3 in a wired or wireless manner. The image forming apparatus 3 to which the information processing apparatus 2 sends the instruction prints the image according to the instruction of the information processing apparatus 2.

The image forming system 1 is also a wireless access point (AP) system. The image forming apparatuses 3a-3d also have the wireless AP functions. When the information processing apparatus 2 is connected with a wireless AP, the information processing apparatus 2 selects one image forming apparatus 3 from the image forming apparatuses 3a-3d and is connected with the selected image forming apparatus 3 by a wireless LAN.

The image forming system 1 comprises a plurality of information processing apparatuses 2. For example, the image forming system 1 can also comprise tens of information processing apparatuses 2. The number of the information processing apparatuses 2 that the image forming system 1 comprises is not limited to a specific number.

The image forming system 1 comprises more than two information processing apparatuses 3. In the example shown in FIG. 1, the image forming system 1 comprises four image forming apparatuses 3. However, the number of the image forming apparatuses 3 that the image forming system 1 comprises is not limited to the specific number.

Subsequently, the information processing apparatus 2 is described.

FIG. 2 is a block diagram roughly illustrating a configuration example of the information processing apparatus 2.

The information processing apparatus 2 can be connected with the wireless AP through the wireless LAN. For example, the information processing apparatus 2 is a desktop computer, a notebook computer, a tablet or a smart phone and the like. The information processing apparatus 2 is not limited to a specific machine.

As shown in FIG. 2, the information processing apparatus 2 comprises a CPU 21, an RAM 22, an ROM 23, an NVM 24, a communication interface (I/F) 25 and the like.

The CPU 21 controls the actions of the whole information processing apparatus 2. The CPU 21 can also comprise an internal cache, various interfaces and the like. The CPU 21 realizes various kinds of processing by executing a program previously stored in an internal memory, the ROM 23 or the NVM 24. For example, the CPU 21 processes data such as data input through the communication interface 25, and the like, by executing the program. In addition, a part of various functions realized by executing the program by the CPU 21 can be also realized by a hardware circuit. In this case, the CPU 21 controls the functions realized by the hardware circuit.

The RAM 22 is a volatile memory. The RAM 22 temporarily stores the data and the like which are being processed by the CPU 21. The RAM 22 stores various application programs according to a command from the CPU 21. In addition, the RAM 22 can also store data needed for executing the application programs and the execution result and the like of the application programs.

The ROM 23 is a non-volatile memory previously storing a control program, control data and the like. The control program and the control data stored in the ROM 22 are previously programmed according to the specification of the information processing apparatus 2. The ROM 23, for example, stores a program (such as a BIOS) and the like controlling a circuit board of the information processing apparatus 2.

The NVM 24 is a non-volatile memory which can carry out the writing and the rewriting of the data. The NVM 24, for example, is a hard disk, an SSD, an EEPROM or a flash memory and the like. The NVM 24 stores the control program, the application and various data according to the utilization purpose of the information processing apparatus 2.

The communication interface (communication I/F) 25 is an interface for carrying out data communication with an external apparatus. The communication interface 25 carries out the communication with the image forming apparatuses 3a-3d or other information processing apparatus 2 and the like through the wireless LAN.

The communication interface 25 sends the on signal to the image forming apparatus 3. The communication interface can also send the on signal to the image forming apparatus 3 through the wireless LAN. In addition, the communication interface 25 can also send the on signal to the image forming apparatus 3 by a unit different from the wireless LAN. The unit for sending the on signal is not limited to a specific method.

The on signal is a signal for turning on the wireless AP function of the image forming apparatus 3. The configuration of the on signal is not limited to a specific configuration.

The information processing apparatus 2 can also comprise a display unit, an operation unit, an external interface and the like. In addition, a component except the above configuration can be also appropriately added to the information processing apparatus 2.

Subsequently, the image forming apparatus 3 (3a, 3b, 3c and 3d) is described.

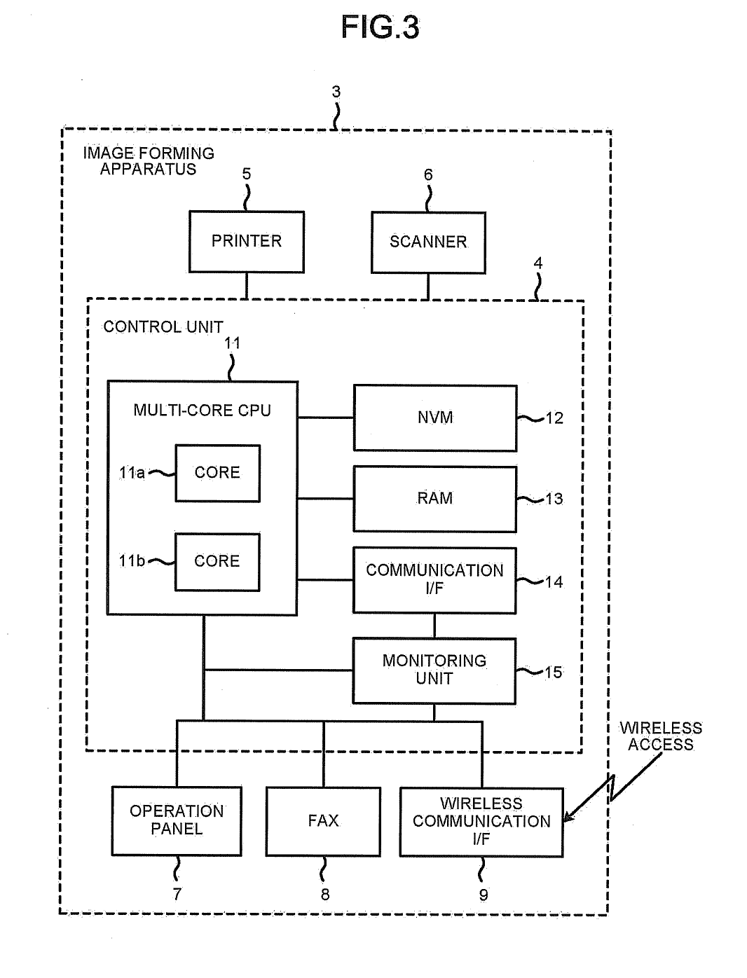

FIG. 3 is a block diagram roughly illustrating a configuration example of the image forming apparatus 3 (3a, 3b, 3c and 3d) according to embodiment 1.

As shown in FIG. 3, the image forming apparatus 3a comprises a control unit 4, a printer 5, a scanner 6, an operation panel 7, a FAX 8 and a wireless communication interface 9. The printer 5 forms the image based on image data. The scanner 6 optically scans the surface of an original and reads the image on the original as the image data.

Each image forming apparatus 3 forms the image on the paper according to a printing request from the information processing apparatus 2. In addition, the image forming apparatus 3 can also carry out copying, scanning or faxing and the like according to an instruction based on the operation panel 5 and coming from the user.

The image forming apparatus 3 has the wireless AP function using the wireless communication. The image forming apparatus 3 can carry out the wireless communication with the information processing apparatus 2 or other image forming apparatus 3 by the wireless communication based on the wireless AP function. The image forming apparatus 3 switches on and off of the wireless AP function.

In order to stably execute the printing, the copying, the scanning or the faxing and the like, the image forming apparatus 3 whose wireless AP function is in an on state partially limits the wireless communication based on the wireless AP function. For example, the image forming apparatus 3 reduces the number of the apparatuses which can be wirelessly connected once by the wireless AP function. By limiting the number of the apparatuses which can be connected, the image forming apparatus 3 prevents from generating influence on the action such as the printing and the like.

When the wireless AP function is off, the image forming apparatus 3 turn ons the wireless AP function according to the on signal from the information processing apparatus 2. Even though the wireless AP function is off, the image forming apparatus 3 can also receive the on signal from the information processing apparatus 2. For example, when the information processing apparatus 2 sends the on signal through the wireless LAN, the image forming apparatus 3 enables a wireless communication function to act with an extent to which the on signal can be received through the wireless LAN. In addition, when the information processing apparatus 2 sends the on signal with the unit different from the wireless LAN, in order to receive the on signal with the unit, the image forming apparatus 3 enables a reception unit corresponding to the unit to act.

The image forming apparatus 3 changes the action of a core of the CPU according to a load. For example, in a state (during the copy) of being carrying out the copying or in a state (readiness) of playing a role as the wireless AP, and the like, the image forming apparatus 3 enables two cores of the CPU to act together. In addition, in a standby state (sleep), the image forming apparatus 3 only enables one of the cores of the CPU to act. In addition, in a state (super sleep) in which the functions are further limited compared with the standby state, the image forming apparatus 3 enables one of the cores of the CPU to act.

For example, if a specified time action instruction does not exist, the image forming apparatus 3 transits to the sleep. In addition, if it is the specified time sleep, the image forming apparatus 3 transits to the super sleep. The state acquired by the image forming apparatus 3, the number of the cores acting according to the state, a condition transiting the state, and the like, are not limited to a specific configuration.

Even in the sleep or the super sleep, the image forming apparatus 3 can also receive the on signal. That is, even in the sleep or the super sleep, the image forming apparatus 3 also does not limit the function of receiving the on signal.

As shown in FIG. 3, the control unit 4 comprises a multi-core CPU 11, an NVM 12, an RAM 13, a wired communication interface (I/F) 14 and a monitoring unit 15. The multi-core CPU 11 is electrically connected with each unit. In addition, the monitoring unit 15 is directly connected with the operation panel 7, the FAX 8, the wireless communication interface 9 and the wired communication interface 14 electrically.

The multi-core CPU 11 synthetically controls the whole image forming apparatus 3 and each unit. The multi-core CPU 11 can also comprise an internal cache, the various interfaces and the like. The multi-core CPU 11 realizes various kinds of processing by executing the program previously stored in the internal memory, the NVM 12 and the like. The multi-core CPU 11 is connected with each unit in the apparatus through a system bus. The multi-core CPU 11 outputs an action instruction to each unit or acquires various kinds of information from each unit by carrying out bidirectional communication with the printer 5, the scanner 6 and the like. In addition, a part of the various functions realized by executing the program by the multi-core CPU 11 can be also the functions realized by the hardware circuit. In this case, the multi-core CPU 11 controls the functions executed by the hardware circuit.

The multi-core CPU 11 has a core 11a and a core 11b. The core 11a and the core 11b are arithmetic units of the multi-core CPU 11. By comprising two cores (the core 11a and the core 11b), the multi-core CPU 11 can carry out arithmetic at a high speed compared with the moment when it comprises one core. In addition, as described above, the multi-core CPU 11 stops one of the core 11a and the core 11b or stops the two according to a state.

The NVM 12 is the non-volatile memory which can carry out the writing and the rewriting of the data. The NVM 12, for example, is the hard disk, the SSD, the EEPROM or the flash memory and the like. The NVM 12 stores the control program, the application and the various data according to the utilization purpose of the information processing apparatus 2.

The RAM 13 is the volatile memory. The RAM 13 temporarily stores the data and the like which are being processed by the multi-core CPU 11. The RAM 13 stores the various application programs according to a command from the multi-core CPU 11. In addition, the RAM 13 can also store the data needed for executing the application programs and the execution result and the like of the application programs.

The communication interface 14 is an interface for carrying out the data communication with the external apparatus. The communication interface 14, for example, is an interface for carrying out the data communication with the apparatus such as the information processing apparatus or the other image forming apparatus 3 and the like through a wired LAN. In addition, the communication interface 14 can also output a signal for starting a specific function in the other image forming apparatus.

The monitoring unit 15 changes the action state of the image forming apparatus 3 from the sleep or the super sleep into a state (such as the readiness) in which the action can be carried out according to the signals from the operation panel 7, the FAX 8, the wireless communication interface 9, the communication interface 14 and the like. That is, the monitoring unit 15 enables the multi-core CPU 11 (core ha and core 11b) to act and enables the multi-core CPU 11 to execute the processing according to the signal from each unit.

For example, if the user operates the operation panel 7, the monitoring unit 15 receives the signal indicating that the user carries out touch from the operation panel 7. If the signal is received, the monitoring unit 15 enables the multi-core CPU 11 to act.

If FAX data are received from an exterior, the FAX 8 sends the signal indicating that a FAX is received to the monitoring unit 15. The monitoring unit 15 receives the signal indicating that the FAX is sent from the exterior from the FAX 8. If the signal is received, the monitoring unit 15 enables the multi-core CPU 11 to act. In addition, the monitoring unit 15 sends the signal indicating that the FAX 8 receives the FAX to the multi-core CPU 11. Thus, the multi-core CPU 11 executes the action of receiving the FAX.

The signal sent by the information processing apparatus 2 by the wireless communication is received by the wireless communication interface 9 of the image forming apparatus 3. For example, the wireless communication interface 9 receives the on signal turning on the wireless AP function from the informing processing apparatus 2. If the on signal is received by the wireless communication interface 9, the monitoring unit 15 detects the situation that the on signal is received from the information processing apparatus 2. For example, if the on signal is detected to be received by the wireless communication interface 9, the monitoring unit 15 enables the multi-core CPU 11 to act. In addition, the monitoring unit 15 sends the signal indicating that the on signal is received to the multi-core CPU 11. The multi-core CPU 11 receives the signal and turn on the wireless AP function.

When the image forming apparatus 3 is in a sleep state, the acting core 11a or 11b can also realize the function of the monitoring unit 15. That is, the acting core 1a or 11b can also receive the signal from the external apparatus, so that the other core 11b or 11a acts.

The operation panel 7 displays the various kinds of information reported to the user. In addition, the operation panel 7 transmits the information input by the user to the control unit 4. The operation panel 7, for example, consists of a liquid crystal display unit with a touch panel, and an operation button.

The wireless communication interface 9 is an interface for carrying out the wireless communication with the external apparatus. The wireless communication interface 9 carries out the communication with the information processing apparatus 2 or the other image forming apparatus 3 and the like through the wireless LAN.

The wireless communication interface 9 also has the function of receiving the signal sent by the information processing apparatus 2 or the other image forming apparatus 3. When the information processing apparatus 2 or the other image forming apparatus 3 sends the on signal turning on the wireless AP function by the wireless communication, the wireless communication interface 9 receives the on signal by the wireless communication. In addition, when the information processing apparatus 2 or the other image forming apparatus 3 supplies the on signal by other unit (such as the communication I/F 14), the image forming apparatus 3 designs a configuration that the information processing apparatus 2 can receive the on signal.

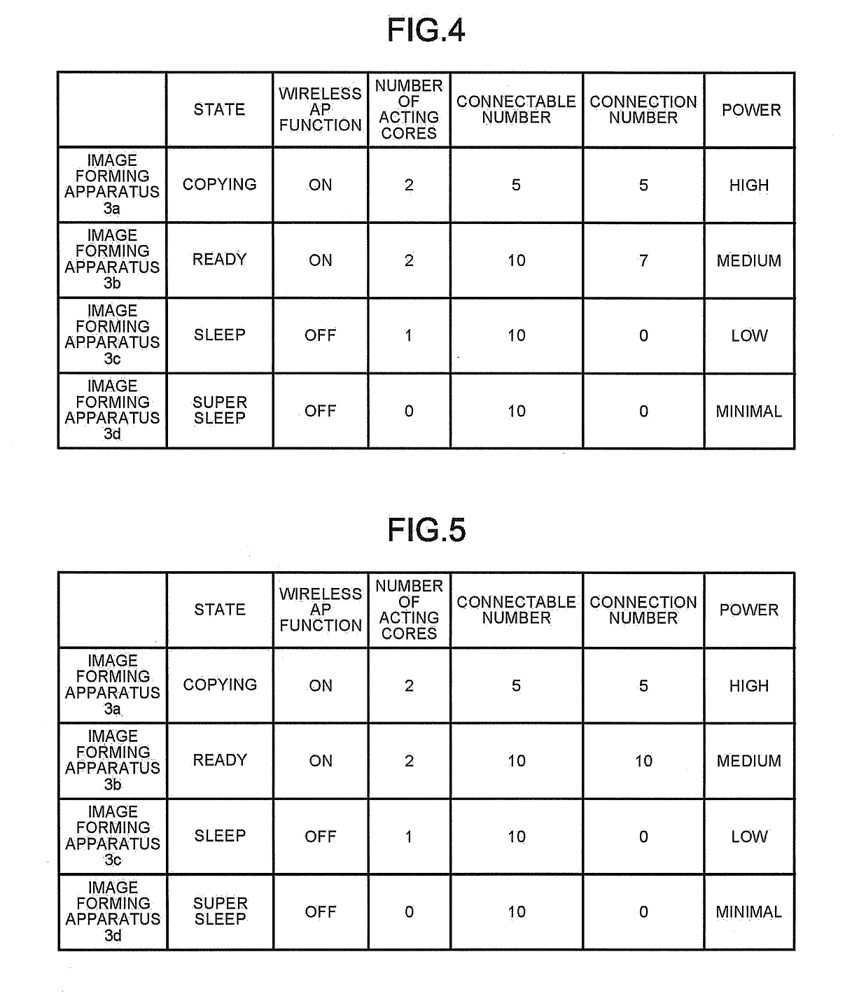

FIG. 4 shows a state example of the image forming apparatuses 3a-3d according to the embodiment.

First, the state example shown in FIG. 4 is described.

The “state” in FIG. 4 shows the action state of the image forming apparatus 3. The “wireless AP function” shows the situation in which the wireless AP function of the image forming apparatus 3 is on or off. The “number of the acting cores” is the number of the cores carrying out the action in the multi-core CPU 11 of the image forming apparatus 3. The “connectable number” is the number of the information processing apparatuses 2 which can be connected with the image forming apparatus 3 as the wireless AP. The “connection number” is the number of the information processing apparatuses 2 which are connected with the image forming apparatus 3 as the wireless AP. The “power” is power consumed by the image forming apparatus 3.

In the state shown in FIG. 4, the image forming apparatus 3a is in “during the copy”. In addition, the image forming apparatus 3a turn on the wireless AP function, so that two cores act.

The image forming apparatus 3a can be connected with five information processing apparatuses 2. As the image forming apparatus 3a is during the copy, a part of the functions of the wireless AP are limited. Therefore, the “connectable number” of the image forming apparatus 3a is lower than the “connectable number” of the other image forming apparatus 3.

The “power” of the image forming apparatus 3a is high. This is because the image forming apparatus 3a most consumes the power when printing the image during the copy and the like.

The image forming apparatus 3b is in the “readiness”. In addition, the image forming apparatus 3b turn on the wireless AP function, so that two cores act.

The “connectable number” of the image forming apparatus 3b is 10. As the image forming apparatus 3b does not carry out the action of the printing, the wireless AP function is not limited. Therefore, the image forming apparatus 3b can be connected with ten information processing apparatuses 2. In addition, the “connection number” of the image forming apparatus 3b is 7. Therefore, the image forming apparatus 3b can be additionally connected with the information processing apparatus 2 as the wireless AP function.

The “power” of the image forming apparatus 3b is medium. This is because the image forming apparatus 3b enables two cores to act, but does not carry out the action of printing the image, such as the copying and the like.

The image forming apparatus 3c is in the “sleep”. The image forming apparatus 3c closes the wireless AP function.

The image forming apparatus 3c only enables one core in the multi-core CPU 11 to act. Therefore, the power consumed by the image forming apparatus 3c is “low”.

The image forming apparatus 3d is in the “super sleep”. The image forming apparatus 3d closes the wireless AP.

The image forming apparatus 3d enables neither of the cores in the multi-core CPU 11 to act. Therefore, the power consumed by the image forming apparatus 3d is “minimal”.

In the state example shown in FIG. 4, when the information processing apparatus 2 is connected with the wireless AP again, the information processing apparatus 2 can be connected with the image forming apparatus 3b. Sequentially, the information processing apparatus 2 does not have to send the on signal for turning on the wireless AP function to the other image forming apparatus 3 (image forming apparatus 3c or image forming apparatus 3d).

Subsequently, a state example shown in FIG. 5 is described.

The state example shown in FIG. 5 is different from the state example shown in FIG. 4 at the point that the “connection number” of the image forming apparatus 3b is 10. Sequentially, descriptions are omitted for other points.

The image forming apparatus 3b is connected with ten information processing apparatuses 2 as the function of the wireless AP. The “connectable number” of the image forming apparatus 3b is 10, and therefore, the image forming apparatus 3b has been connected with the information processing apparatuses 2 with a number the same as that of the information processing apparatuses 2 which can be connected as the function of the wireless AP. Sequentially, the image forming apparatus 3b cannot be additionally connected with the information processing apparatus 2 again as the function of the wireless AP.

In the state example shown in FIG. 5, when the information processing apparatus 2 is connected with the wireless AP again, the information processing apparatus 2 cannot be connected with the image forming apparatus 3 (image forming apparatus 3a or image forming apparatus 3b) turning on the wireless AP function at present. Sequentially, the information processing apparatus 2 must send the on signal for turning on the wireless AP function to the other image forming apparatus 3 (image forming apparatus 3c or image forming apparatus 3d).

Subsequently, an action example of the image forming system 1 is described.

The information processing apparatus 2 used in the descriptions is not connected with any one of the image forming apparatuses 3a-3d. In addition, the image forming apparatus 2 is intended to be connected with any one wireless AP function of the image forming apparatuses 3a-3d again.

First, the information processing apparatus 2 explores the image forming apparatus 3 whose wireless AP function is on through the communication interface 25. That is, the information processing apparatus 2 receives the electric wave of the wireless LAN by the communication interface 25.

If the image forming apparatus 3 whose wireless AP function is on is discovered, the information processing apparatus 2 requests wireless LAN connection towards the image forming apparatus 3 through the communication interface 25. When a plurality of image forming apparatuses whose wireless AP functions are on are discovered, the information processing apparatus 2 can also request the wireless LAN connection towards the nearest (that is, receiving the electric wave most strongly) image forming apparatus 3.

The image forming apparatus 3 receives the request of the wireless LAN connection from the information processing apparatus 2. If the request of the wireless LAN connection is received, the image forming apparatus 3 determines whether or not the wireless LAN connection can be established with the information processing apparatus 2. That is, the image forming apparatus 3 compares the “connectable number” with the “connection number”, and determines that the wireless LAN connection can be established with the information processing apparatus 2 when the “connection number” is less than the “connectable number”. In addition, when the “connection number” and the “connectable number” are the same in number, it is determined that the image forming apparatus 3 cannot establish the wireless LAN connection with the information processing apparatus 2.

For example, in the state example shown in FIG. 4, when the information processing apparatus 2 requests to carry out the wireless LAN connection on the image forming apparatus 3b, it is determined that the image forming apparatus 3b can establish the wireless LAN connection with the information processing apparatus 2.

In a state example shown in Fig. (b), when the information processing apparatus 2 requests the wireless LAN connection towards the image forming apparatus 3b, it is determined that the image forming apparatus 3b cannot establish the wireless LAN connection with the information processing apparatus 2.

If it is determined that the image forming apparatus 3 can establish the wireless LAN connection with the information processing apparatus 2, the image forming apparatus 3 establishes the wireless LAN connection with the information processing apparatus 2.

The information processing apparatus 2 establishes the wireless LAN connection with the image forming apparatus 3. If the wireless LAN connection is established with the image forming apparatus 3, the information processing apparatus 2 sends or receives the various data through the wireless LAN connection with the image forming apparatus 3. If the sending or the reception of the various data is ended, the information processing apparatus 2 cuts off the wireless LAN connection with the image forming apparatus 3.

The image forming apparatus 3 cuts off the wireless LAN connection with the information processing apparatus 2. If the wireless LAN connection with the information processing apparatus 2 is interrupted, whether or not the apparatus in the wireless LAN connection with the image forming apparatus 3 exists additionally is determined. If it is determined that other apparatus in the wireless LAN connection does not exist, the image forming apparatus 3 closes the wireless AP function. In addition, if it is determined that the apparatus in the wireless LAN connection exists additionally, the image forming apparatus 3 maintains the wireless AP function to be an on original form.

If it is determined that the image forming apparatus 3 towards which the information processing apparatus 2 requests to carry out the wireless LAN connection cannot establish the wireless LAN connection with the information processing apparatus 2, the image forming apparatus 3 refuses the request of the wireless LAN connection with the information processing apparatus 2.

Furthermore, the information processing apparatus 2 failing in the wireless LAN connection with the image forming apparatus 3 explores the image forming apparatus 3 whose wireless AP function is on. When the other image forming apparatus 3 whose wireless AP function is on is discovered, the information processing apparatus 2 requests to carry out the wireless LAN connection on the image forming apparatus 3. The actions after the wireless LAN connection is requested are the same as the above actions.

When the other image forming apparatus 3 whose wireless AP function is on is not discovered, the information processing apparatus 2 sends the on signal to the image forming apparatus 3 whose wireless AP function is off. When the plurality of image forming apparatuses 3 whose wireless AP functions are off exist, the information processing apparatus 2 can also send the on signal to the nearest image forming apparatus 3. In addition, the information processing apparatus 2 can also send the on signal to the image forming apparatus 3 according to a predetermined order.

Herein, the information processing apparatus 2 can also previously recognize the image forming apparatus 3 whose wireless AP function is off. In this case, the user and the like can also input the information identifying the image forming apparatus 3 whose wireless AP function is off to the information processing apparatus 2. For example, the user previously inputs the position and the identification number of the image forming apparatus whose wireless AP function is off to the image forming apparatus 3.

Even though the wireless AP function is off, the image forming apparatus 3 can also send the signal illustrating that the wireless AP function exists to the information processing apparatus 2. At the moment, the information processing apparatus 2 has the function of receiving the signal. The information processing apparatus 2 can also recognize the image forming apparatus 3 whose wireless AP function is off according to the signal.

A method for recognizing the image forming apparatus 3 closing the wireless AP function by the information processing apparatus 2 is not limited to a specific method.

For example, in the state example shown in FIG. 5, the information processing apparatus 2 fails in the wireless LAN connection with the image forming apparatuses 3a and 3b. At the moment, furthermore, the information processing apparatus 2 cannot discover the other image forming apparatus 3 whose wireless AP function is on. Furthermore, if other image forming apparatus 3 whose wireless AP function is on cannot be discovered, the information processing apparatus 2 sends the on signal to the other image forming apparatus 3 (image forming apparatus 3c or 3d). For example, the information processing apparatus 2 sends the on signal to the image forming apparatus 3c.

The image forming apparatus 3 whose wireless AP function is off receives the on signal from the information processing apparatus 2. If the on signal is received, the image forming apparatus 3 turn on the wireless AP function. For example, when the image forming apparatus 3 is in the sleep or the super sleep, the monitoring unit 15 enables the cores 11a and lib to act. The monitoring unit 15 enables the core 11a and the core 11b carrying out the action to turn on the wireless AP function.

For example, in the above example, the image forming apparatus 3c receives the on signal from the information processing apparatus 2. As the image forming apparatus 3c is in the sleep, the monitoring unit 15 receives the on signal. If the on signal is received, the monitoring unit 15 enables the dormant core 11a or 11b to act. If the monitoring unit 15 enables the core 11a or core 11b to act, the multi-core CPU 11 turn on the wireless AP function.

If the image forming apparatus 3 turn on the wireless AP function, the information processing apparatus 2 requests the wireless LAN connection towards the image forming apparatus 3. The actions after the wireless LAN connection is requested are the same as the above actions.

Subsequently, an action example of the information processing apparatus 2 is described.

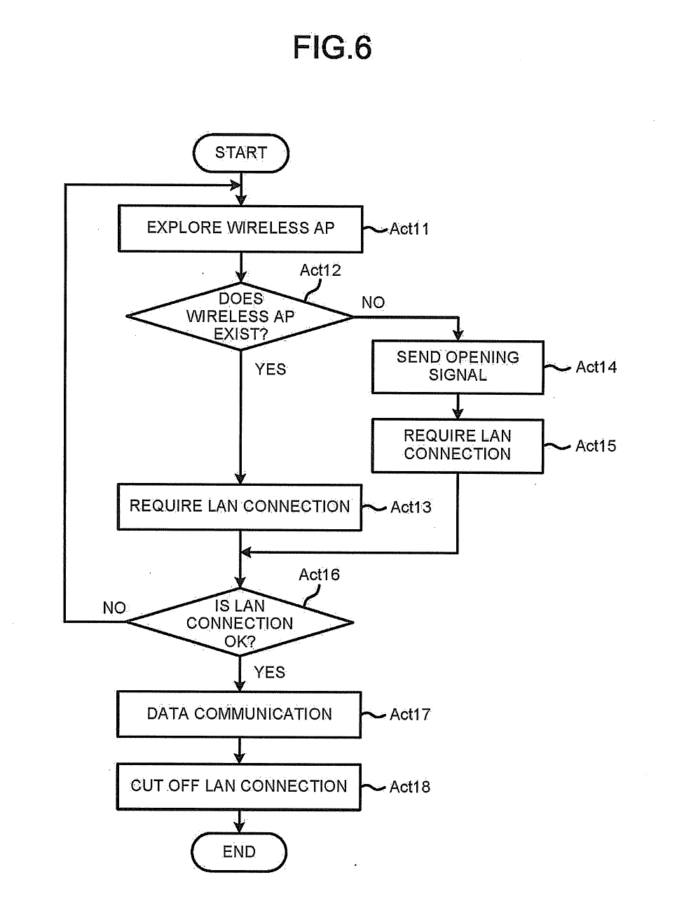

FIG. 6 is a flow chart for describing the action example of the information processing apparatus 2.

First, the CPU 21 of the information processing apparatus 2 explores the image forming apparatus 3 whose wireless AP function is changed into the on state (Act 11). The CPU 21 sends the electric wave requesting a response from the image forming apparatus 3 whose wireless AP function is in the on state by the communication interface 25. The CPU 21 explores the image forming apparatus 3 whose wireless AP function is changed into the on state according to the reception status of a response signal based on the communication interface 25. In addition, as the processing in Act 11 after two times, the CPU 21 explores the image forming apparatus 3 which still does not request the wireless LAN connection from the image forming apparatus 3 whose wireless AP function is in the on state.

If the image forming apparatus 3 whose wireless AP function is in the on state is discovered (Act 12, YES), the CPU 21 requests the wireless LAN connection towards the image forming apparatus 3 (Act 13). As the CPU 21 carries out the wireless LAN connection with the image forming apparatus 3 by the wireless AP function, the wireless LAN connection is requested towards the image forming apparatus 3 by the wireless communication.

When the image forming apparatus 3 whose wireless AP function is in the on state cannot be discovered (Act 12, NO), the CPU 21 sends the on signal turning on the wireless AP function to the image forming apparatus 3 whose wireless AP function is in an off state (Act 14).

If the on signal is sent, the CPU 21 requests the wireless LAN connection towards the image forming apparatus (Act 15). As the CPU 21 carries out the wireless LAN connection with the image forming apparatus 3 by the wireless AP function, the CPU 21 requests the wireless LAN connection towards the image forming apparatus 3 to which the on signal is sent.

When the wireless LAN connection is requested towards the image forming apparatus 3 (Act 13) or the wireless LAN connection is requested towards the image forming apparatus 3 (Act 14), the CPU 21 determines whether or not the wireless LAN connection is established with the image forming apparatus 3 (Act 16). That is, the CPU 21 determines whether or not the request of the wireless LAN connection is recognized.

If it is determined that the wireless LAN connection is established with the image forming apparatus 3 (Act 16, YES), the CPU 21 sends and receives the data with the image forming apparatus 3 according to the instruction of the user and the like (Act 17).

If the sending and the reception of the data with the image forming apparatus 3 are ended, the CPU 21 cuts off the wireless LAN connection with the image forming apparatus 3 (Act 18).

If the wireless LAN connection with the image forming apparatus 3 is cut off, the CPU 21 ends the action.

If it is determined that the wireless LAN connection with the image forming apparatus 3 fails (Act 16, NO), the CPU 21 returns to Act 11 and explores the wireless AP again.

Subsequently, an action example of the image forming apparatus 3 is described.

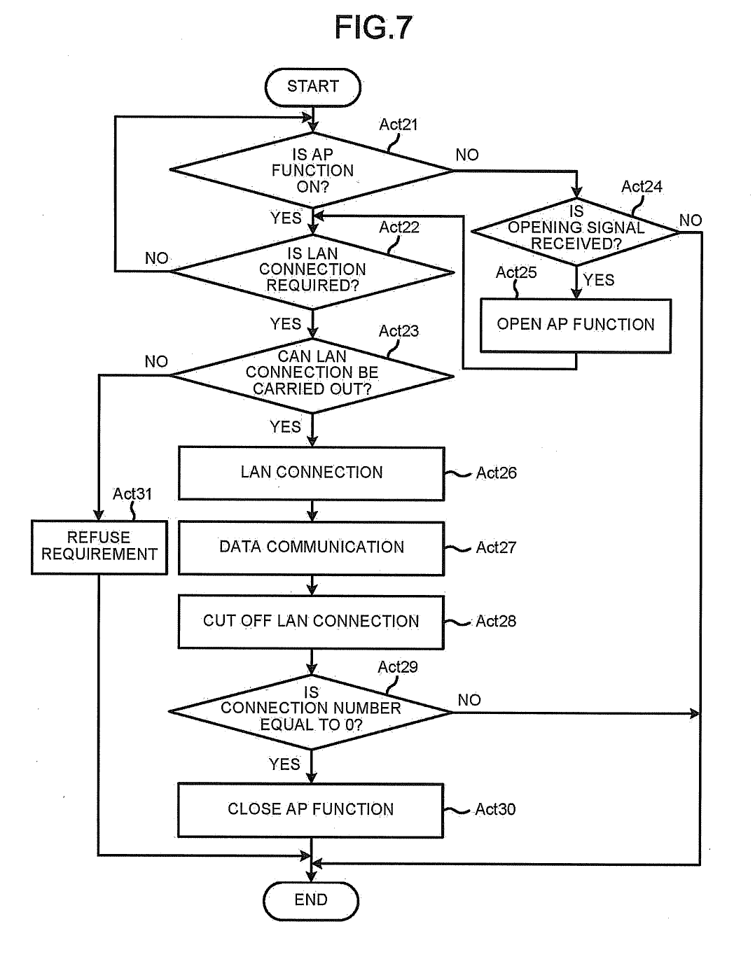

FIG. 7 is a flow chart for describing the action example of the image forming apparatus 3.

First, the multi-core CPU 11 of the image forming apparatus 3 determines whether or not the self wireless AP function is on (Act 21).

If it is determined that the wireless AP function is not on, the multi-core CPU 11 determines whether or not the on signal is received (Act 24). That is, the multi-core CPU 11 determines whether or not the on signal is relieved by the monitoring unit 15, the wireless communication interface 9 and the like. In addition, it can also determine whether or not the monitoring unit 15 receives the on signal.

When it is determined that the on signal is received (Act 24, YES), the multi-core CPU 11 turn on the wireless AP function (Act 25). In addition, when it is determined that the monitoring unit 15 receives the on signal, the monitoring unit 15 enables the multi-core CPU 11 to act. The acting multi-core CPU 11 turn on the wireless AP function.

When it is determined that the wireless AP function is on (Act 21, YES) or the wireless AP function is on (Act 25), the multi-core CPU 11 determines whether or not the request of the wireless LAN connection from the information processing apparatus 2 exists (Act 22). That is, the multi-core CPU 11 determines whether or not the request of the wireless LAN connection is received from the information processing apparatus 2 through the wireless communication interface 9.

If it is determined that the request of the wireless LAN connection does not exist from the information processing apparatus 2 (Act 23, NO), the multi-core CPU 11 returns to Act 21.

If it is determined that the request of the wireless LAN connection exists from the information processing apparatus 2 (Act 22, YES), the multi-core CPU 11 determines whether it can establish the wireless LAN connection with the information processing apparatus 2 (Act 23). That is, the multi-core CPU 11 compares the “connectable number” with the “connection number” and determines whether or not the “connection number” has an margin.

If it is determined that the wireless LAN connection can be established with the information processing apparatus 2 (Act 23, YES), the multi-core CPU 11 establishes the wireless LAN connection with the information processing apparatus 2 (Act 26). If the wireless LAN connection is established with the information processing apparatus 2, the multi-core CPU 11 sends and receives the data with the information processing apparatus 2 (Act 27). If the sending and the reception of the data are ended with the information processing apparatus 2, the multi-core CPU 11 cuts off the wireless LAN connection with the information processing apparatus 2 (Act 28).

If the wireless LAN connection with the information processing apparatus 2 is cut off, the multi-core CPU 11 determines whether or not the “connection number” is equal to 0 (Act 29). That is, the multi-core CPU 11 determines whether or not the information processing apparatus 2 connected with the wireless AP exists additionally.

If it is determined that the “connection number” is equal to 0 (Act 29, YES), the multi-core CPU 11 closes the self wireless AP function (Act 30).

If it is determined that the wireless LAN connection cannot be established with the information processing apparatus 2 (Act 23, NO), the multi-core CPU 11 refuses the wireless LAN connection with the information processing apparatus 2 (Act 31).

When it is determined that the on signal is not received (Act 24, NO), it is determined that the “connection number” is not equal to 0 (Act 29, NO) or the wireless LAN connection is refused (Act 31), the multi-core CPU 11 ends the action.

The image forming system constituted in that way above can close the wireless AP function of the image forming apparatus which does not establish the wireless LAN connection with the information processing apparatus. In addition, when the information processing apparatus cannot establish the wireless LAN connection with the image forming apparatus, the information processing apparatus can turn on the wireless AP function of the image forming apparatus whose wireless AP function is off. Thus, the image forming system 1 can close the unnecessary wireless AP function and can inhibit power consumption.

### Embodiment 2

Subsequently, an embodiment 2 is described.

The image forming system 1 to which embodiment 2 relates is different from the image forming system 1 in the embodiment 1 in the point in which the image forming apparatus 3 sends the on signal. In its conventional point, the image forming system 1 to which the embodiment 2 relates is the same as the image forming system 1 in the embodiment 1.

The configuration of the information processing apparatus 2 to which the embodiment 2 relates is the same as that of the information processing apparatus 2 according to embodiment 1, and therefore, the descriptions are omitted.

Subsequently, the configuration of the image forming apparatus 3 to which the embodiment 2 relates is described.

The configuration of the image forming apparatus 3 to which the embodiment 2 relates is different from the configuration of the image forming apparatus 3 according to embodiment 1 in the point in which the wireless communication interface 9 of the image forming apparatus 3 sends the on signal. Sequentially, the descriptions are omitted for other points.

Besides the function of the wireless communication interface 9 of the image forming apparatus 3 according to embodiment 1, the wireless communication interface 9 can also send the on signal.

That is, the wireless communication interface 9 sends the on signal to the other image forming apparatus 3. The wireless communication interface 9 can also send the on signal to the other image forming apparatus 3 through the wireless LAN. In addition, the wireless communication interface 9 can also send the on signal to the other image forming apparatus 3 by the unit different from the wireless LAN. The unit for sending the on signal is not limited to the specific method.

The wireless communication interface 9 receives the on signal sent by the other image forming apparatus 3. When the other image forming apparatus 3 sends the on signal through the wireless LAN, the wireless communication interface 9 receives the on signal through the wireless LAN. In addition, when the other image forming apparatus 3 sends the on signal with the other unit, the wireless communication interface 9 receives the on signal by a unit corresponding to the unit.

Subsequently, an action example of the image forming system 1 is described.

The information processing apparatus 2 used in the descriptions is not connected with any one of the image forming apparatuses 3a-3d. In addition, the image forming apparatus 2 is intended to be connected with any one wireless AP function of the image forming apparatuses 3a-3d again. In addition, the state of the image forming system 1 is the state shown in FIG. 5.

First, the information processing apparatus 2 explores the image forming apparatus 3 whose wireless AP function is on through the communication interface 25. That is, the information processing apparatus 2 receives the electric wave of the wireless LAN through the communication interface 25.

The information processing apparatus 2 discovers the image forming apparatus 3a or 3b whose wireless AP function is on. The information processing apparatus 2 requests to carry out the wireless LAN connection with any one of the image forming apparatus 3a or 3b through the communication interface 25. Herein, the information processing apparatus 2 requests to carry out the wireless LAN connection with the image forming apparatus 3a.

The image forming apparatus 3a receives the request of the wireless LAN connection from the information processing apparatus 2. If the request of the wireless LAN connection is received, the image forming apparatus 3a determines whether or not the wireless LAN connection can be established with the information processing apparatus 2. As the wireless LAN connection with a number the same as the connectable number has been established, the image forming apparatus 3a determines that the wireless LAN connection cannot be established with the information processing apparatus 2. If it is determined that the wireless LAN connection cannot be established with the information processing apparatus 2, the image forming apparatus 3a refuses the request of the wireless LAN connection from the information processing apparatus 2. Meanwhile, the image forming apparatus 3a records the identification information of the information processing apparatus 2 as the identification information of the apparatus towards which the image forming apparatus 3a refuses the request of the wireless LAN connection. For example, the identification information is the identification number and the like of the information processing apparatus 2. The identification information is not limited to specific information.

The information processing apparatus 2 explores the image forming apparatus 3 towards which the information processing apparatus 2 still does not request the wireless LAN connection. If the image forming apparatus 3 is explored, the information processing apparatus 2 discovers the image forming apparatus 3b. If the image forming apparatus 3a is discovered, the information processing apparatus 2 requests to carry out the wireless LAN connection with the image forming apparatus 3b.

The image forming apparatus 3b receives the request of the wireless LAN connection from the information processing apparatus 2. The same as the image forming apparatus 3a, the image forming apparatus 3b cannot also establish the wireless LAN connection with a new information processing apparatus 2 and refuses the request of the wireless LAN connection from the information processing apparatus 2.

The information processing apparatus 2 again explores the image forming apparatus 3 towards which the information processing apparatus 2 still does not request the wireless LAN connection. However, the information processing apparatus 2 cannot discover the image forming apparatus 3 towards which the information processing apparatus 2 still does not request the wireless LAN connection. If the image forming apparatus 3 cannot be discovered, the information processing apparatus 2 requests the wireless LAN connection towards the image forming apparatus 3 (that is, the image forming apparatus 3a) towards which the wireless LAN connection is requested initially.

The image forming apparatus 3a receives the request of the wireless LAN connection from the information processing apparatus 2. The image forming apparatus 3a cannot establish the wireless LAN connection with the new information processing apparatus 2 and refuses the request of the wireless LAN connection from the information processing apparatus 2. Meanwhile, the image forming apparatus 3a refers to the identification information of the apparatus towards which the image forming apparatus 3a refused the request of the wireless LAN connection in the past. The image forming apparatus 3a determines whether or not the situation that the information processing apparatus 2 requested the wireless LAN connection towards the image forming apparatus 3a in the past exists by referring to the identification information. As the information processing apparatus 2 has already requested the wireless LAN connection towards the image forming apparatus 3a, the image forming apparatus 3a recognizes the situation that the information processing apparatus 2 requested the wireless LAN connection towards the image forming apparatus 3a in the past.

Thus, the image forming apparatus 3a recognizes that the image forming apparatus 3 whose connection number has margin does not exist. The information processing apparatus 2 requests the wireless LAN connection towards the image forming apparatus 3 in sequence. Sequentially, so to speak, at the moment when the wireless LAN connection is requested again towards the same image forming apparatus 3, the information processing apparatus requests the wireless LAN connection towards all the image forming apparatuses 3 whose wireless AP is on.

If the information processing apparatus 2 is recognized to request the wireless LAN connection towards the image forming apparatus 3a in the past, the image forming apparatus 3a sends the on signal to the image forming apparatus 3 (that is, the image forming apparatus 3c or 3d) whose wireless AP function is off through the wireless communication interface 9. The image forming apparatus 3a can also send the on signal to the image forming apparatus 3 which is the nearest to the information processing apparatus 2. In addition, the information processing apparatus 2 can also send the on signal to the image forming apparatus 3 according to the predetermined sequence. A method for determining the image forming apparatus 3 to which the image forming apparatus 3a sends the on signal is not limited to the specific method. Herein, the image forming apparatus 3a sends the on signal to the image forming apparatus 3c.

The image forming apparatus 3c receives the on signal from the image forming apparatus 3a. If the on signal is received, the image forming apparatus 3c turn on the wireless AP function.

The information processing apparatus 2 again explores the image forming apparatus 3 towards which the information processing apparatus 2 still does not request the wireless LAN connection. If the image forming apparatus 3 is explored, the information processing apparatus 2 discovers the image forming apparatus 3c. If the image forming apparatus 3c is discovered, the information processing apparatus 2 requests the wireless LAN connection towards the image forming apparatus 3c.

The image forming apparatus 3c receives the request of the wireless LAN connection from the information processing apparatus 2. If the request of the wireless LAN connection is received, the image forming apparatus 3c determines whether or not the image forming apparatus 3c can establish the wireless LAN connection with the information processing apparatus 2. As the wireless LAN connection can be still established, it is determined that the wireless LAN connection can be established with the information processing apparatus 2.

If it is determined that the wireless LAN connection can be established with the information processing apparatus 2, the image forming apparatus 3c establishes the wireless LAN connection with the information processing apparatus 2.

The information processing apparatus 2 establishing the wireless LAN connection with the image forming apparatus 3c sends or receives the various data with the image forming apparatus 3c through the wireless LAN connection. If the sending or the reception of the various data is ended, the information processing apparatus 2 cuts off the wireless LAN connection with the image forming apparatus 3c.

The image forming apparatus 3c towards which the wireless LAN connection is cut off by the information processing apparatus 2 determines whether or not the apparatus establishing the wireless LAN connection exists additionally. If it is determined that the apparatus establishing other wireless LAN connection does not exist, the image forming apparatus 3c closes the wireless AP function. In addition, if it is determined that the apparatus establishing the wireless LAN connection exists additionally, the image forming apparatus 3c maintains the wireless AP function to be the on original form.

Subsequently, an action example of the information processing apparatus 2 is described.

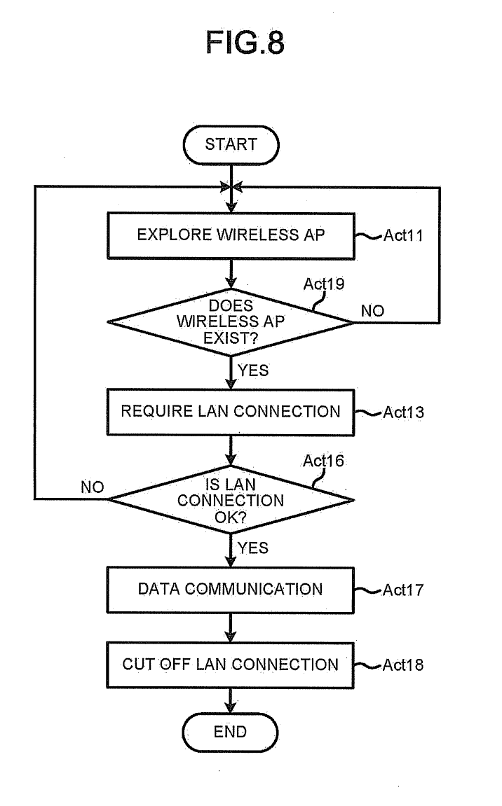

FIG. 8 is a flow chart for describing the action example of the information processing apparatus 2.

First, the CPU 21 of the information processing apparatus 2 explores the image forming apparatus 3 whose wireless AP function is changed into the on state (Act 11).

If the image forming apparatus 3 whose wireless AP function is in the on state is discovered (Act 19, YES), the CPU 21 requests the wireless LAN connection towards the image forming apparatus 3 (Act 13). That is, as the wireless LAN connection is carried out with the image forming apparatus 3 by the wireless AP function, the CPU 21 requests the wireless LAN connection towards the image forming apparatus 3 executing the wireless AP function by the wireless communication.

When the image forming apparatus 3 whose wireless AP function is in the on state cannot be discovered (Act 19, NO), the CPU 21 returns to Act 11.

Other action example of the information processing apparatus 2 is the same as the action example of the information processing apparatus 2 according to embodiment 1. Sequentially, the descriptions are omitted for other actions.

Subsequently, an action example of the image forming apparatus 3 is described.

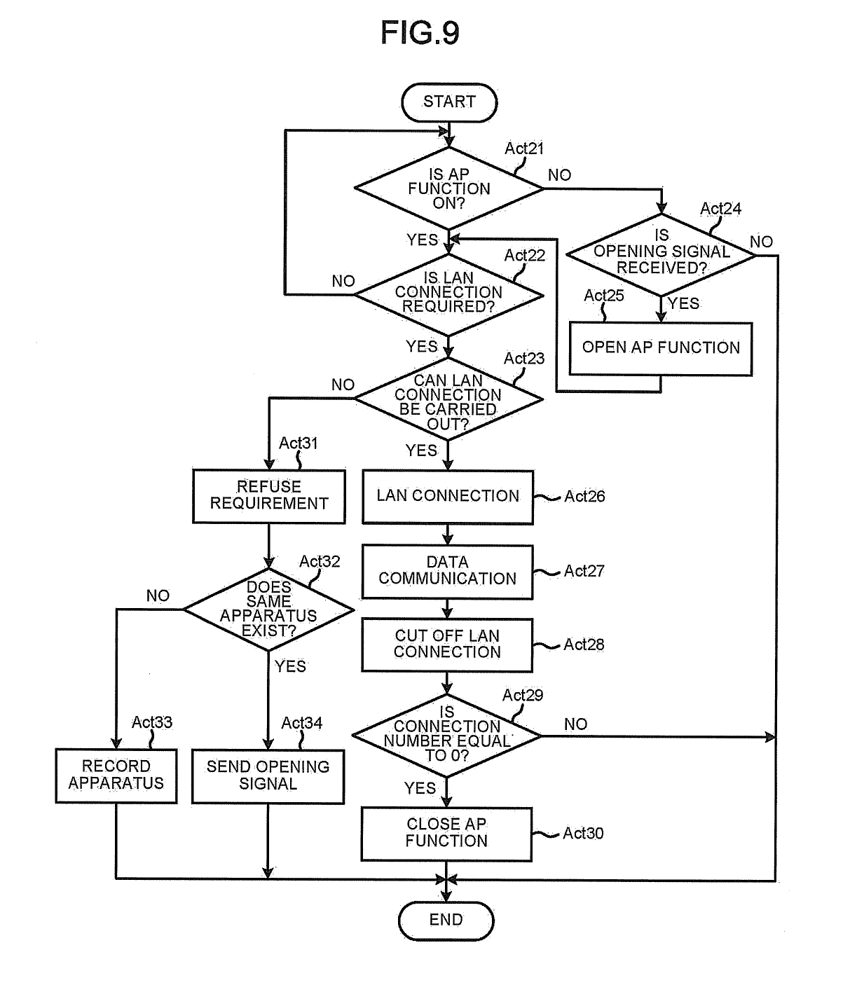

FIG. 9 is a flow chart for describing the action example of the image forming apparatus 3.

The action example of the image forming apparatus 3 is different from the action example of the image forming apparatus 3 according to embodiment 1 after Act 32. Sequentially, the descriptions are omitted for the actions before Act 31.

The multi-core CPU 11 refuses the wireless LAN connection with the information processing apparatus 2 (Act 31).

If the wireless LAN connection with information processing apparatus 2 is refused, the multi-core CPU 11 determines whether or not the wireless LAN connection from the same information processing apparatus 2 was refused in the past (Act 32). That is, the multi-core CPU 11 refers to the identification information of the apparatus towards which the image forming apparatus 3 refused the wireless LAN connection in the past. The multi-core CPU 11 determines whether or not the identification information of the information processing apparatus 2 is included in the identification information.

If it is determined that the wireless LAN connection from the same information processing apparatus 2 was not refused in the past (Act 32, NO), the multi-core CPU 11 records the identification information of the information processing apparatus 2 as the identification information of the information processing apparatus 2 towards which the wireless LAN connection is refused by the image forming apparatus 3 (Act 33). In addition, the multi-core CPU 11 can also record the identification information towards the RAM 13 or the NVM 12.

If it is determined that the wireless LAN connection from the same information processing apparatus 2 was refused in the past (Act 32, YES), the multi-core CUP 11 sends the on signal turning on the wireless AP function to the image forming apparatus 3 whose wireless AP function is in the off state (Act 34).

When the identification information of the information processing apparatus 2 is recorded (Act 33) or the on signal is sent to the image forming apparatus 3 whose wireless AP function is in the off state (Act 34), the multi-core CPU 11 ends the action.

In the image forming system 1 constituted in that way as above, the wireless AP function of the image forming apparatus 3 which does not establish the wireless LAN connection with the information processing apparatus 2 can be closed. In addition, when the information processing apparatus 2 cannot establish the wireless LAN connection, the image forming apparatus 3 can turn on the wireless AP function of the image forming apparatus 3 whose wireless AP function is off. Thus, the information processing apparatus 2 does not need to have the function of sending the on signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a wireless communication interface configured to carry out wireless communication;
an exploration unit configured to explore an image forming apparatus that is the state that can be connected by wireless communication based on a wireless access point function;
a communication establishment unit configured to establish the wireless communication connection with the image forming apparatus that is the state that can be connected by wireless communication based on a wireless access point function; and
a communication processing unit configured to supply an on signal turning on the wireless access point function to the image forming apparatus whose wireless access point function is off when the exploration unit determines that the image forming apparatus that is the state that can be connected by wireless communication based on a wireless access point function does not exist.

2. The information processing apparatus according to claim 1, wherein
after the wireless connection is refused from the image forming apparatus whose wireless access point function is in an on state, the exploration unit again explores another image forming apparatus whose wireless access point function is in the on state.

3. An image forming apparatus, comprising:
a wireless communication interface configured to carry out wireless communication;
a communication control unit configured to turn on a wireless access point function using the wireless communication interface when an on signal turning on the wireless access point function is given; and
an image forming unit configured to form an image on paper according to a printing request from an information processing apparatus establishing wireless communication connection in a state that the wireless access point function is in an on state.

4. The image forming apparatus according to claim 3, further comprising:
a first memory configured to store the number of the apparatuses wirelessly connected by the wireless access point function, wherein the communication control unit closes the wireless access point function when the number of the apparatuses wirelessly connected which is stored in the first memory is 0.

5. The image forming apparatus according to claim 3, further comprising:
a first memory configured to store the number of the apparatuses wirelessly connected by the wireless access point function; and
a second memory configured to record the connectable number which is the upper limit value of the number of the apparatuses wirelessly connected by the wireless access point function, wherein
the communication control unit refuses new wireless connection when the number of the apparatuses wirelessly connected which is recorded by the first memory is the connectable number recorded by the second memory.

6. The image forming apparatus according to claim 3, further comprising:
a second communication control unit configured to supply the on signal turning on the wireless access point to other image forming apparatus when the wireless connection with the information processing apparatus is refused.

7. The image forming apparatus according to claim 6, wherein
the second communication control unit supplies the on signal to the other image forming apparatus when the wireless access point refuses a wireless connection request from the same information processing apparatus twice.

8. An image forming system, comprising:
a plurality of information processing apparatuses configured to be connected with a wireless access point; and
a plurality of image forming apparatuses configured to have wireless access point functions, wherein
the information processing apparatus includes:
a wireless communication interface configured to carry out wireless communication;
an exploration unit configured to explore the image forming apparatus that is the state that can be connected by wireless communication based on a wireless access point function; and
a communication establishment unit configured to establish the wireless communication connection with the image forming apparatus that is the state that can be connected by wireless communication based on a wireless access point function,
the image forming apparatus includes:
a second wireless communication interface configured to carry out the wireless communication;
a communication control unit configured to turn on the wireless access point function using the wireless communication interface when an on signal turning on the wireless access point function is given; and
an image forming unit configured to form an image on paper according to a printing request from the information processing apparatus establishing the wireless communication connection in a state that the wireless access point function is in an on state.

9. The image forming system according to claim 8, wherein
the information processing apparatus includes a communication processing unit configured to supply the on signal for turning on the wireless access point function to the image forming apparatus whose wireless access point function is off when the exploration unit determines that the image forming apparatus of which is the state of the wireless communication connection based on the wireless access point function does not exist.

10. The image forming system according to claim 8, wherein
the image forming apparatus includes a second communication control unit configured to supply the on signal turning on the wireless access point to other image forming apparatus when the wireless connection with the information processing apparatus is refused.
